(19) United States
(12) Patent Application Publication
(10) Pub. No.: US 2017/0256031 A1
(43) Pub. Date: Sep. 7, 2017

(54) METHOD OF ENLARGING CONTENT IN DIVIDED SCREEN, INFORMATION PROCESSING APPARATUS, AND CONTROL METHOD AND CONTROL PROGRAM OF INFORMATION PROCESSING APPARATUS

(71) Applicant: NEC Corporation, Tokyo (JP)

(72) Inventor: Akira KAMEI, Tokyo (JP)

(73) Assignee: NEC Corporation, Tokyo (JP)

(21) Appl. No.: 15/511,001

(22) PCT Filed: May 11, 2015
(86) PCT No.: PCT/JP2015/063477

§ 371 Date: Mar. 13, 2017

(30) Foreign Application Priority Data
Sep. 16, 2014 (JP) 2014-188304

(51) Int. Cl. G06T 3/40; G06T 11/60; G06F 3/14; G06F 3/0488; G06F 3/0484

(52) U.S. Cl. CPC G06T 3/40; G06F 3/04883; G06F 3/04845; G06F 3/1431; G06T 11/60; G06F 2203/04806; G06F 2203/04803

(57) ABSTRACT

This invention provides an information processing apparatus for enlarging and displaying a content in a divided screen in a size easy to see without limitation to the divided screen. The information processing apparatus includes a divided display control unit that displays at least two divided screens, and an enlarged display control unit that displays, when enlarging a content in one of the at least two divided screens, the enlarged content with superimposing the enlarged content on a boundary between the at least two divided screens. The enlarged display control unit generates a display frame that is different from display frames of the at least two divided screens and includes the enlarged content, and displays the display frame with superimposing the display frame on the boundary between the at least two divided screens.

### TECHNICAL FIELD

The present invention relates to a method of enlarging a content in a divided screen, an information processing apparatus, and a control method and control program of the information processing apparatus.

### BACKGROUND ART

In the above technical field, patent literature 1 discloses a technique of enlarging each pane displayed by dividing a screen (see FIG. 31).

### CITATION LIST

### Patent Literature

Patent literature 1: Japanese Patent Laid-Open No. 2014-132427

### SUMMARY OF THE INVENTION

### Technical Problem

In the technique described in the above literature, however, enlarged display is limited within a pane region. Therefore, even if a content (for example, a photo or moving image) in the pane region is enlarged and displayed, it may be too small to see.

The present invention enables to provide a technique of solving the above-described problem.

### Solution to Problem

One aspect of the present invention provides an information processing apparatus comprising:

a divided display control unit that displays at least two divided screens; and

an enlarged display control unit that displays, when enlarging a content in one of the at least two divided screens, the enlarged content with superimposing the enlarged content on a boundary between the at least two divided screens.

Another aspect of the present invention provides a control method of an information processing apparatus, comprising:

displaying at least two divided screens; and

displaying, when enlarging a content in one of the at least two divided screens, the enlarged content with superimposing the enlarged content on a boundary between the at least two divided screens.

Still other aspect of the present invention provides a control program of an information processing apparatus for causing a computer to execute a method, comprising:

displaying at least two divided screens; and

displaying, when enlarging a content in one of the at least two divided screens, the enlarged content with superimposing the enlarged content on a boundary between the at least two divided screens.

Still other aspect of the present invention provides a method of enlarging a content in at least two divided screens, comprising:

determining an enlargement operation of a content in the at least two divided screens; and

enlarging the content in accordance with the enlargement operation and displaying the enlarged content with superimposing the enlarged content on a boundary between the at least two divided screens.

### Advantageous Effects of Invention

According to the present invention, it is possible to enlarge and display a content in a divided screen in a size easy to see without limitation to the divided screen.

### BRIEF DESCRIPTION OF DRAWINGS

FIG. 1 is a block diagram showing the arrangement of an information processing apparatus according to the first embodiment of the present invention;

FIG. 2 is a view showing the operation of the enlargement processing of an information processing apparatus according to the second embodiment of the present invention;

FIG. 3 is a block diagram showing the functional arrangement of the information processing apparatus according to the second embodiment of the present invention;

FIG. 4 is a table showing the structure of display frame information according to the second embodiment of the present invention;

FIG. 5 is a table showing the structure of an enlargement processing determination table according to the second embodiment of the present invention;

FIG. 6 is a table showing the structure of an enlargement end determination table according to the second embodiment of the present invention;

FIG. 7 is a block diagram showing the hardware arrangement of the information processing apparatus according to the second embodiment of the present invention;

FIG. 8 is a flowchart illustrating the processing procedure of the information processing apparatus according to the second embodiment of the present invention;

FIG. 9 is a flowchart illustrating a display frame control procedure according to the second embodiment of the present invention;

FIG. 10 is a view showing the operation of the enlargement end processing of an information processing apparatus according to the third embodiment of the present invention;

FIG. 11 is a table showing the structure of an enlargement end determination table according to the third embodiment of the present invention;

FIG. 12 is a flowchart illustrating the processing procedure of the information processing apparatus according to the third embodiment of the present invention;

FIG. 13 is a view showing the operation of the enlargement end processing of an information processing apparatus according to the fourth embodiment of the present invention;

FIG. 14 is a table showing the structure of an enlargement end determination table according to the fourth embodiment of the present invention;

FIG. 15 is a flowchart illustrating the processing procedure of the information processing apparatus according to the fourth embodiment of the present invention;

FIG. 16 is a view showing the operation of the enlargement end processing of an information processing apparatus according to the fifth embodiment of the present invention;

FIG. 17 is a table showing the structure of an enlargement processing determination table according to the fifth embodiment of the present invention;

FIG. 18 is a flowchart illustrating the processing procedure of the information processing apparatus according to the fifth embodiment of the present invention;

FIG. 19 is a view showing the operation of the enlargement processing of an information processing apparatus according to the sixth embodiment of the present invention; and

FIG. 20 is a view showing the operation of the enlargement processing of an information processing apparatus according to the seventh embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

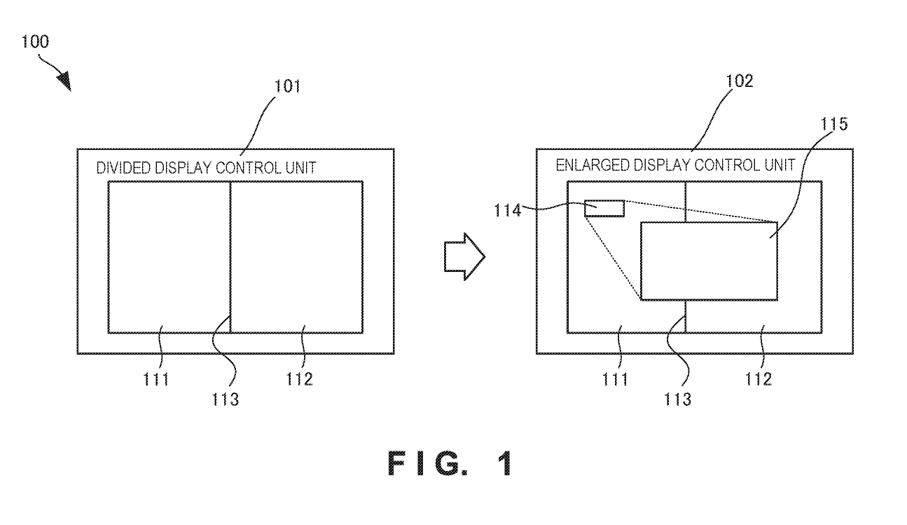

An information processing apparatus 100 according to the first embodiment of the present invention will be described with reference to FIG. 1. The information processing apparatus 100 is an apparatus having a display screen.

As shown in FIG. 1, the information processing apparatus 100 includes a divided display control unit 101 and an enlarged display control unit 102. The divided display control unit 101 displays at least two divided screens 111 and 112. When enlarging a content 114 in one of the two divided screens 111 and 112, the enlarged display control unit 102 superimposes and displays an enlarged content 115 on a boundary 113 between the two divided screens 111 and 112.

According to this embodiment, it is possible to enlarge and display a content in a divided screen in a size easy to see without limitation to the divided screen.

### Second Embodiment

An information processing apparatus according to the second embodiment of the present invention will be described next. The information processing apparatus according to this embodiment enlarges a content in one of divided screens by a pinch-out operation or tap operation on the content, and superimposes and displays the content on the boundary between the divided screens. Note that the following content enlargement operation will be exemplified as a pinch-out operation. However, an image or moving image enlargement operation is implemented by a tap operation on a display region. That is, the operation is intuitive processing of opening a temporary browsing window. The enlarged display of the content ends when a period during which no operation is performed for the content exceeds a predetermined time.

### Enlargement Processing Operation

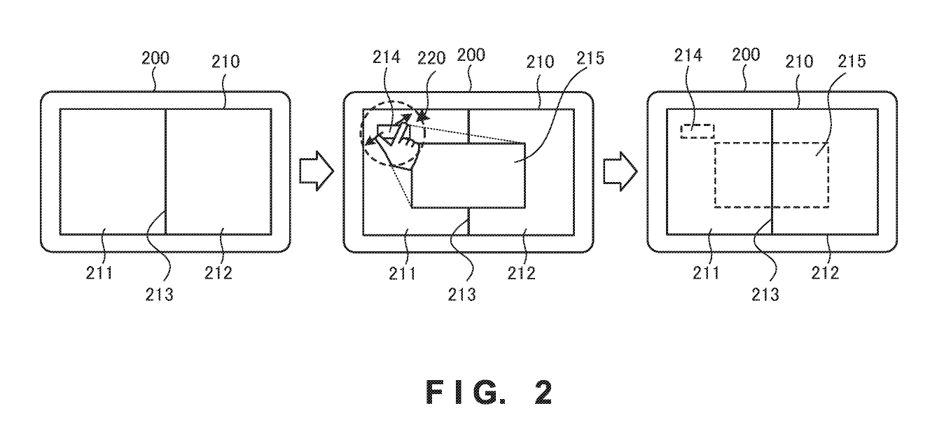

FIG. 2 is a view showing the operation of the enlargement processing of an information processing apparatus 200 according to this embodiment. FIG. 2 shows, from left, divided screens, the enlargement operation and enlarged display of a content 214, and the end of enlargement.

Screens 211 and 212 are divisionally displayed on a display screen 210 of the information processing apparatus 200 to have a boundary 213 (see the left view). In this example, if an enlargement instruction for the content 214 displayed on one screen 211 is issued by a pinch-out operation 220, an enlarged content 215 is superimposed and displayed on the boundary 213 between the screens 211 and 212 (see the central view).

If a predetermined time elapses while no operation is performed for the enlarged content after enlarged display is performed, the enlarged display processing ends to return to the original divided display (see the right view).

### Functional Arrangement of Information Processing Apparatus

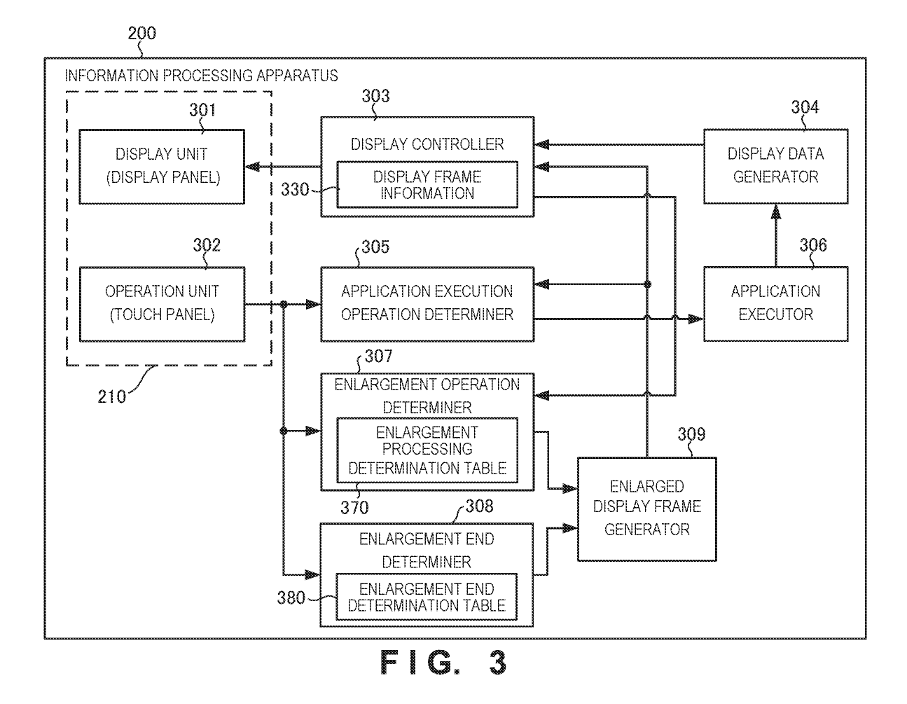

FIG. 3 is a block diagram showing the functional arrangement of the information processing apparatus 200 according to this embodiment.

The information processing apparatus 200 includes the display screen 210 formed by a display unit 301 with a display panel and an operation unit 302 with a touch panel. The information processing apparatus 200 includes a display controller 303, a display data generator 304, an application execution operation determiner 305, and an application executor 306.

The application execution operation determiner 305 determines an application execution operation in the operation unit 302. In the case of the application execution operation, the application executor 306 activates an application, and executes it. The display data generator 304 generates display data according to the executed application. The display controller 303 has display frame information 330, assigns, to a display frame, the display data generated by executing the application, and displays the display data on the display unit 301.

Furthermore, the information processing apparatus 200 includes an enlargement operation determiner 307, an enlargement end determiner 308, and an enlarged display frame generator 309. The enlargement operation determiner 307 has an enlargement processing determination table 370, determines enlargement processing based on an operation in the operation unit 302, and notifies the enlarged display frame generator 309 of a determination result. The enlargement end determiner 308 has an enlargement end determination table 380, determines the end of enlargement based on an operation in the operation unit 302, and notifies the enlarged display frame generator 309 of a determination result.

The enlarged display frame generator 309 generates a display frame in which the enlarged content is displayed from the start to end of enlargement processing, and provides the display frame for the enlarged content to the display controller 303. The display controller 303 superimposes and displays, on the boundary between the divided screens of the display unit 301, the enlarged content assigned to the enlarged display frame. This makes it possible to enlarge and display the content in a size easy to see without limitation to the boundary between the divided screens.

### Display Frame Information

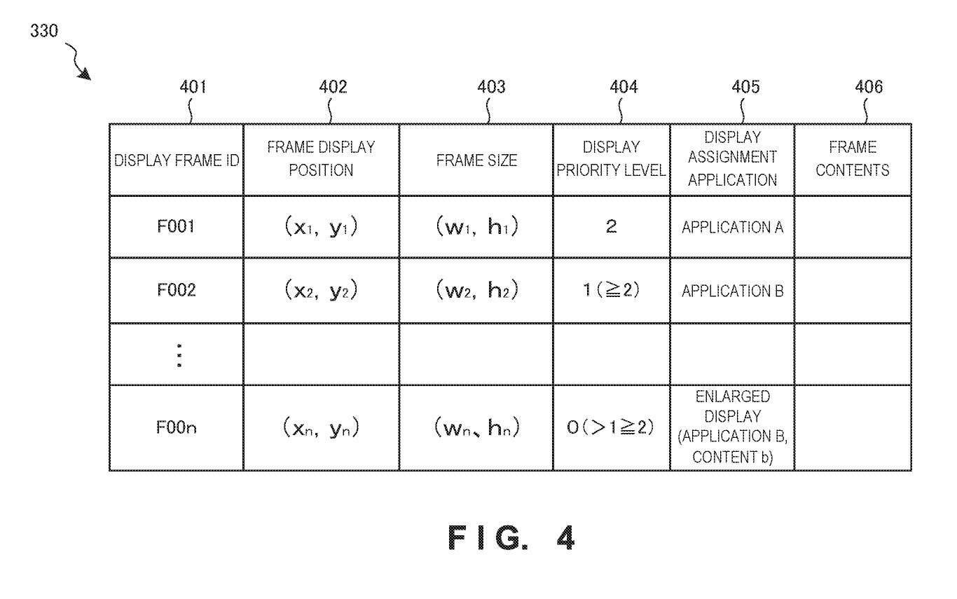

FIG. 4 is a view showing the structure of the display frame information 330 according to this embodiment. The display frame information 330 is used by the display controller 303 to arrange display information related to the application on a screen. Note that in FIG. 4, for each display frame, different numerical values are set also in a frame display position and frame size in the y-axis direction (vertical direction) in order to maintain the generality. However, in the case of the divided screens in the x-axis direction (horizontal direction) shown in FIG. 2, the same values of y and h are set for all display frames.

The display frame information 330 stores a display position 402 and a size 403 of each display frame in association with a display frame ID 401. Note that a display position may be the upper left of a display frame but is not limited to this. In addition, instead of the display position 402 and the size 403, two display positions of corners of the display frame may be stored. The display frame information 330 also stores a display priority level 404 of the display frame ID 401. The display priority level 404 is used to superimpose and display frames.

The display frame information 330 stores, in association with the display frame ID 401, as a display assignment application 405, an application for generating information to be displayed on the display frame. Frame contents 406 generated by the application are stored.

### Enlargement Processing Determination Table

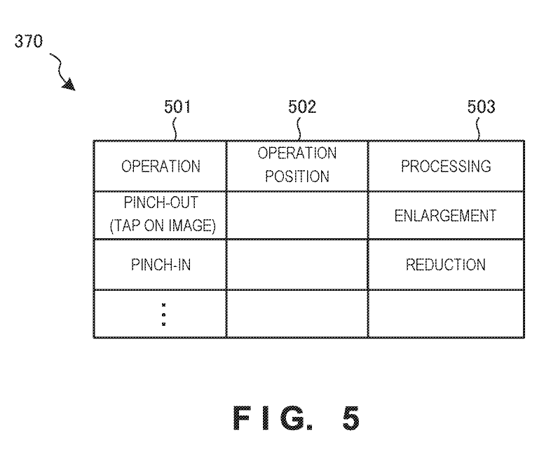

FIG. 5 is a table showing the structure of the enlargement processing determination table 370 according to this embodiment. The enlargement processing determination table 370 is used to determine an operation of instructing enlarged display of a content. Note that a case in which a pinch-out operation as a touch operation by the user on the display screen corresponds to an enlargement operation will be described with reference to FIG. 5. For example, however, the enlargement operation is not limited to this, and may be a touch on an enlargement button on the screen.

The enlargement processing determination table 370 stores processing 503 in association with an operation 501 and an operation position 502.

### Enlargement End Determination Table

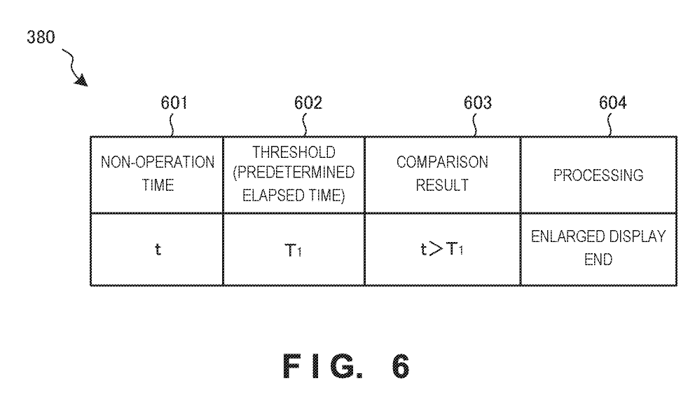

FIG. 6 is a table showing the structure of the enlargement end determination table 380 according to this embodiment. The enlargement end determination table 380 is used to determine an operation of ending the enlarged display of the content. Note that in this example, the end of the enlarged display is determined based on not a specific end operation but a non-operation time.

The enlargement end determination table 380 stores a non-operation elapsed time (t) 601, a threshold (T1) 602 of a predetermined elapsed time, a comparison result 603, and processing 604 based on the comparison result. In FIG. 6, since the non-operation elapsed time (t) exceeds the time threshold (T1), enlarged display end processing is determined.

### Hardware Arrangement of Information Processing Apparatus

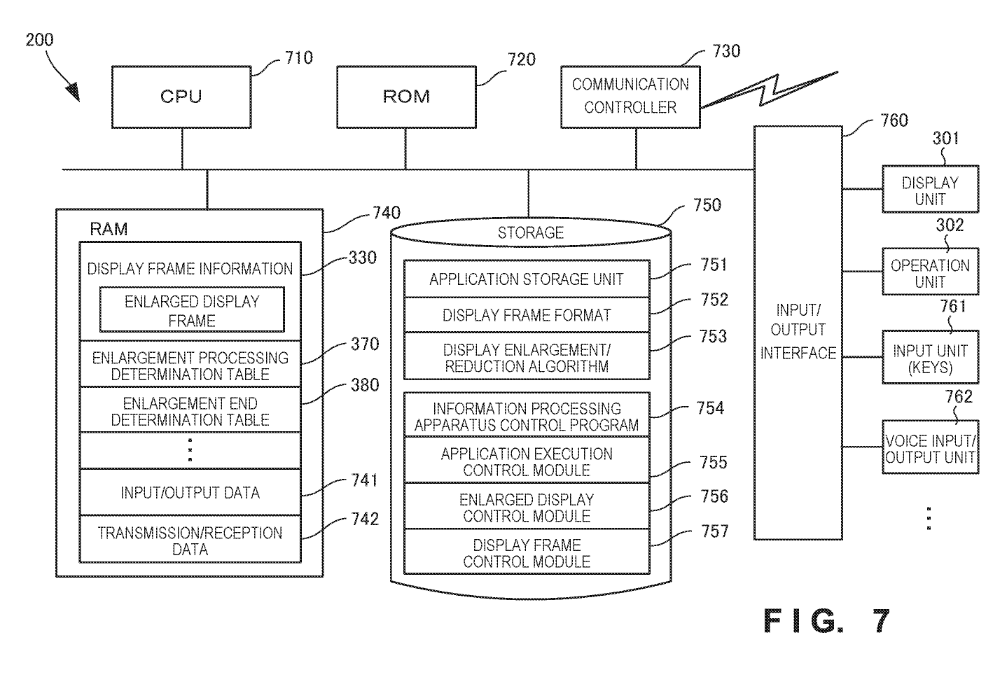

FIG. 7 is a block diagram showing the hardware arrangement of the information processing apparatus 200 according to this embodiment.

Referring to FIG. 7, a CPU (Central Processing Unit) 710 is an arithmetic control processor, and implements the functional components of the information processing apparatus 200 shown in FIG. 3 by executing a program. A ROM (Read Only Memory) 720 stores permanent data such as initial data and a program, and programs. A communication controller 730 communicates with another apparatus via a network. Note that the number of CPUs 710 is not limited to one, and a plurality of CPUs or a GPU (Graphic Processing Unit) for image processing may be included. The communication controller 730 desirably includes a CPU independent of the CPU 710, and writes or reads out transmission/reception data in or from the area of a RAM (Random Access Memory) 740. It is desirable to provide a DMAC (Direct Memory Access Controller) (not shown) for transferring data between the RAM 740 and a storage 750. Furthermore, an input/output interface 760 desirably includes a CPU independent of the CPU 710, and writes or reads out input/output data in or from the area of the RAM 740. Therefore, the CPU 710 processes the data by recognizing that the data has been received by or transferred to the RAM 740. Furthermore, the CPU 710 prepares a processing result in the RAM 740, and delegates succeeding transmission or transfer to the communication controller 730, DMAC, or input/output interface 760.

The RAM 740 is a random access memory used as a temporary storage work area by the CPU 710. An area to store data necessary for implementation of the embodiment is allocated to the RAM 740. The display frame information 330 stores the definition of a display frame including an enlarged display frame to be superimposed and displayed, and the relation with an application. The enlargement processing determination table 370 is a table for determining an enlargement operation. The enlargement end determination table 380 is a table for determining the end of enlarged display. The input/output data 741 are transfer data exchanged with the display unit 301 and the operation unit 302 via the input/output interface 760. The transmission/reception data 742 are data transmitted/received via the communication controller 730.

The storage 750 stores a database, various parameters, or the following data or programs necessary for implementation of the embodiment. An application storage unit 751 stores applications executed by the information processing apparatus 200. A display frame format 752 stores the formats of the display frames stored in the display frame information 330. A display enlargement/reduction algorithm 753 stores a processing scheme of enlarging and reducing display data.

The storage 750 stores the following programs. An information processing apparatus control program 754 is a basic program for controlling the overall information processing apparatus 200. An application execution control module 755 is a module for executing applications stored in the application storage unit 751. An enlarged display control module 756 is a module for enlarging an instructed content when an enlargement operation is determined using the enlargement processing determination table 370. A display frame control module 757 is a module for controlling the arrangement, on the display unit 301, of the display frames assigned with pieces of display information generated by executing the applications.

The input/output interface 760 interfaces input/output data with an input/output device. The input/output interface 760 is connected to the display unit 301, the operation unit 302, an input unit 761 with hardware keys, a voice input/output unit 762, and the like. A GPS (Global Positioning System) position determiner may also be connected.

Note that programs and data which are associated with the general-purpose functions of the information processing apparatus 200 and other feasible functions are not shown in the RAM 740 or the storage 750 of FIG. 7.

### Processing Procedure of Information Processing Apparatus

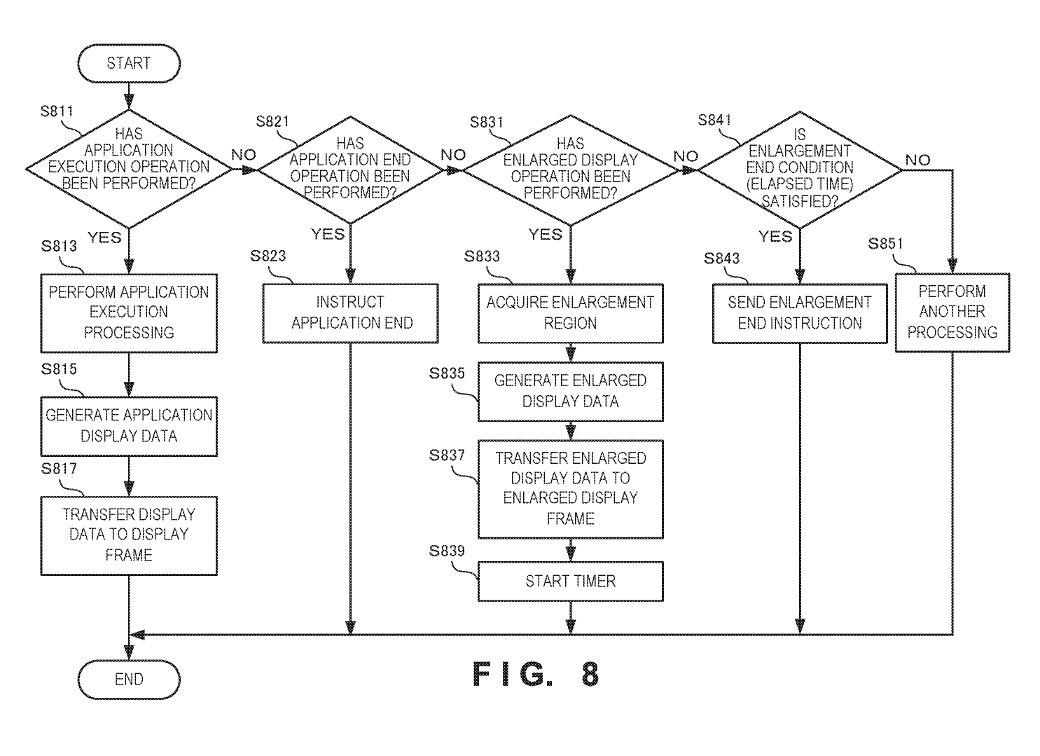

FIG. 8 is a flowchart illustrating the processing procedure of the information processing apparatus 200 according to this embodiment. This flowchart is executed by a CPU 710 of FIG. 7 using a RAM 740, thereby implementing the functional components of FIG. 3.

In step S811, the information processing apparatus 200 determines whether an application execution operation has been performed on a display screen. If an application execution operation has been performed, the information processing apparatus 200 executes an instructed application in step S813. In step S815, the information processing apparatus 200 generates display data related to execution of the application. In step S817, the information processing apparatus 200 transfers the generated display data to display it in an assigned display frame.

If no application execution operation has been performed, the information processing apparatus 200 determines in step S821 whether an operation of ending the currently executed application has been performed. If the operation of ending the currently executed application has been performed, the information processing apparatus 200 instructs end of the executed application in step S823.

If neither an application execution operation nor an application end operation has been performed, the information processing apparatus 200 determines in step S831 whether a content enlarged display operation has been performed on the display screen. In this example, a pinch-out operation on an enlargement target content corresponds to an enlarged display operation. If the content enlarged display operation has been performed, the information processing apparatus 200 acquires, in step S833, the region of the enlargement target content. For example, as for an image, the entire image is acquired. As for a moving image, the region of a moving image view is acquired. In step S835, the information processing apparatus 200 generates display data by enlarging the enlargement target content. In step S837, the information processing apparatus 200 transfers the enlarged display data to an enlarged display frame to be superimposed and displayed on the boundary between the divided screens. In step S839, the information processing apparatus 200 starts a timer to determine the end of enlargement.

If none of an application execution operation, an application end operation, and a content enlargement operation has been performed, the information processing apparatus 200 determines in step S841 whether an enlarged display end condition based on an elapsed time is satisfied. If the enlarged display end condition is satisfied, in this example, when the time counted by the timer exceeds a threshold, the information processing apparatus 200 sends an enlargement end instruction in step S843.

If none of an application execution operation, an application end operation, a content enlargement operation, and a content enlargement end operation has been performed, the information processing apparatus 200 performs, in step S851, another processing instructed and operated.

### Display Frame Control

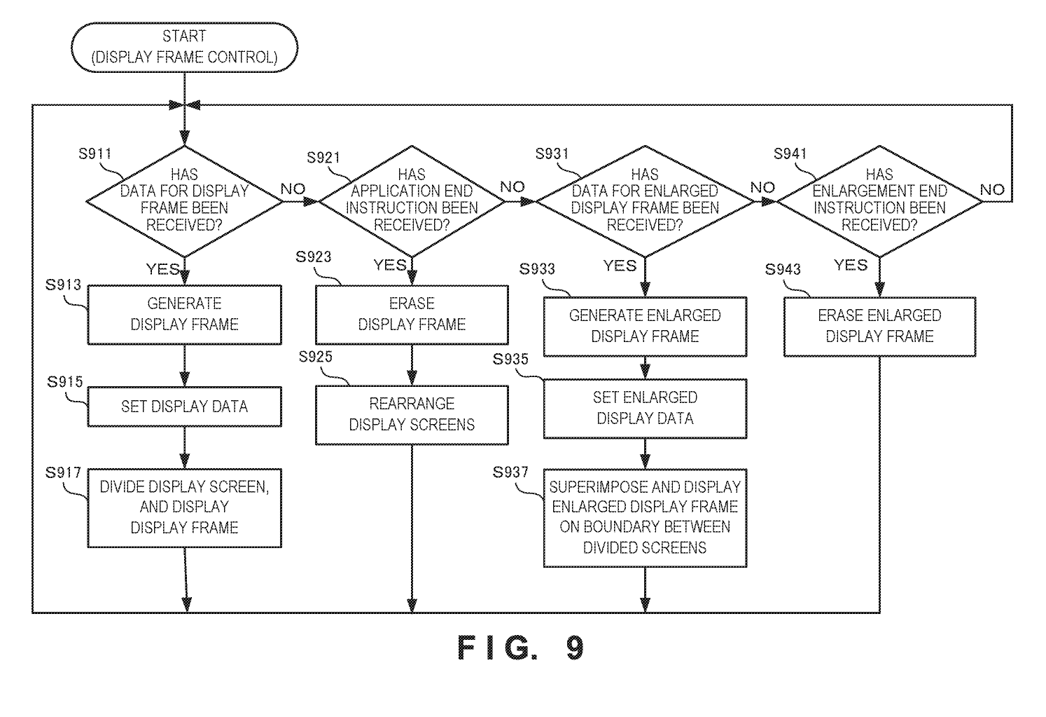

FIG. 9 is a flowchart illustrating a display frame control procedure according to this embodiment.

In step S911, the information processing apparatus 200 determines whether data for a display frame has been received by the processing in step S817 of FIG. 8. If data for a display frame has been received, the information processing apparatus 200 generates a display frame in step S913. Next, in step S915, the information processing apparatus 200 sets the received display data in the generated display frame. In step S917, the information processing apparatus 200 divides the display screen, and displays the display data of the display frame. Note that the procedure of dividing the display screen has been explained in steps S913 to S917 above. If divided screens are generated by a plurality of display frames, the display data is assigned to a display frame in correspondence with the application, and generation of a display frame in step S913 is unnecessary.

If no data for a display frame has been received, the information processing apparatus 200 determines in step S921 whether an application end instruction has been received that had been instructed in step S823 of FIG. 8. If the application end instruction has been received, the information processing apparatus 200 erases, in step S923, the display frame in which the display data is displayed. In step S925, the information processing apparatus 200 rearranges the display screens. Note that if the divided screens are preset, as described above, data are rearranged in the opened display frames, and erase of the display frame in step S923 is unnecessary.

If neither data for a display frame nor an application end instruction has been received, the information processing apparatus 200 determines in step S931 whether enlarged display data for an enlarged display frame has been received by the processing in step S837 of FIG. 8. If enlarged display data for an enlarged display frame has been received, the information processing apparatus 200 generates an enlarged display frame different from the divided screens in step S933. Next, in step S935, the information processing apparatus 200 sets the received enlarged display data in the generated enlarged display frame. In step S937, the information processing apparatus 200 superimposes and displays the enlarged display data of the enlarged display frame on the boundary between the divided screens.

If none of data for a display frame, an application end instruction, and enlarged display data has been received, the information processing apparatus 200 determines in step S941 whether an enlargement end instruction has been received by the processing in step S843 of FIG. 8. If the enlargement end instruction has been received, the information processing apparatus 200 erases, in step S943, the enlarged display frame superimposed and displayed on the boundary.

According to this embodiment, in accordance with an enlargement operation on the screen, it is possible to enlarge and display a content in a divided screen in a size easy to see without limitation to the divided screen.

### Third Embodiment

An information processing apparatus according to the third embodiment of the present invention will be described next. The information processing apparatus according to this embodiment is different from that according to the second embodiment in that enlarged display is continued and an enlargement end operation is performed in response to a tap operation outside an enlarged content region. The remaining components and operations are the same as those in the second embodiment. Hence, the same reference numerals denote the same components and operations, and a detailed description thereof will be omitted.

### Enlargement End Processing Operation

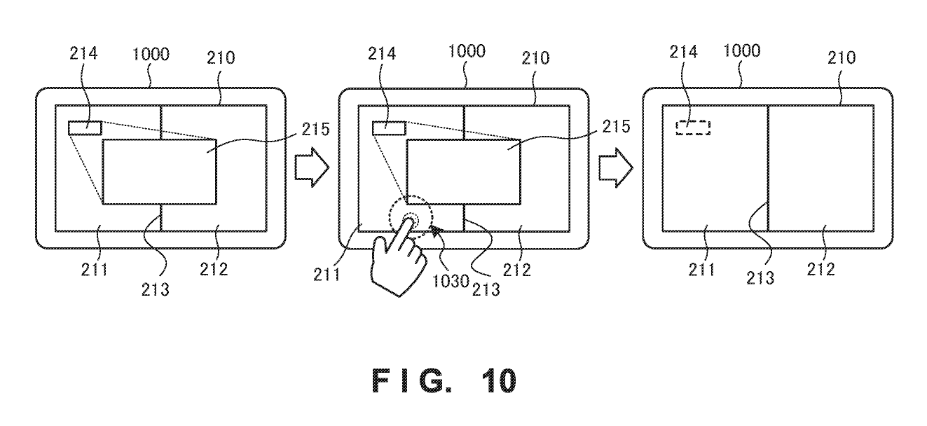

FIG. 10 is a view showing the operation of the enlargement end processing of an information processing apparatus 1000 according to this embodiment. FIG. 10 shows, from left, the enlargement operation and enlarged display of a content 214, an enlargement end operation, and a state after the end of enlargement.

Screens 211 and 212 are divisionally displayed on a display screen 210 of the information processing apparatus 1000 to have a boundary 213. If an enlargement instruction is issued for the content 214, an enlarged content 215 is superimposed and displayed on the boundary 213 between the screens 211 and 212.

If a tap operation 1030 is performed on the screen 211 or 212 outside the region of the enlarged and displayed content 215 during the enlarged display, the enlarged display processing ends to return to the original divided display (see the right view). Note that FIG. 10 shows an example in which the tap operation 1030 is performed on the screen 211 outside the region of the enlarged and displayed content 215. However, the same applies to a case in which the tap operation 1030 is performed on the screen 212 outside the enlarged content 215. Alternatively, the tap operation may be limited within a screen including the enlarged and displayed content.

### Enlargement End Determination Table

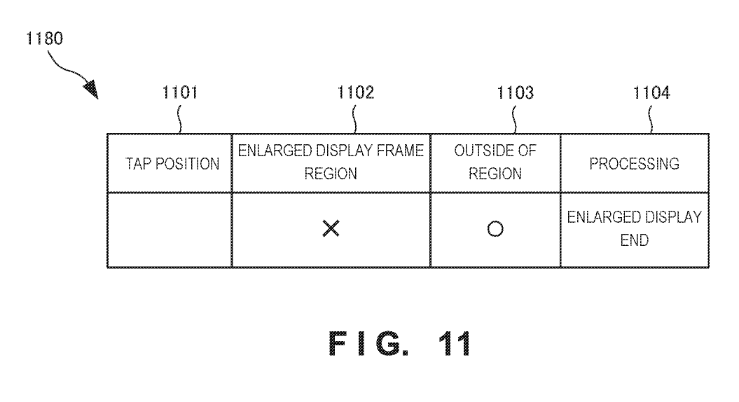

FIG. 11 is a table showing the structure of an enlargement end determination table 1180 according to this embodiment. The enlargement end determination table 1180 is used to determine an operation of ending the enlarged display of the content. Note that in this example, the end of the enlarged display is determined based on a tap operation on the screen 211 or 212 outside the region of the enlarged and displayed content. In this embodiment, the enlargement end determination table 1180 is used instead of the enlargement end determination table 380 shown in FIG. 3.

The enlargement end determination table 1180 stores processing 1104 in association with a position 1101 at which a tap operation has been performed and a result of determining whether the position 1101 falls inside (1102) or outside (1103) the enlarged displayed frame region. In FIG. 11, the position 1101 at which the tap operation has been performed falls within the enlarged display frame region, enlarged display end processing is determined.

### Processing Procedure of Information Processing Apparatus

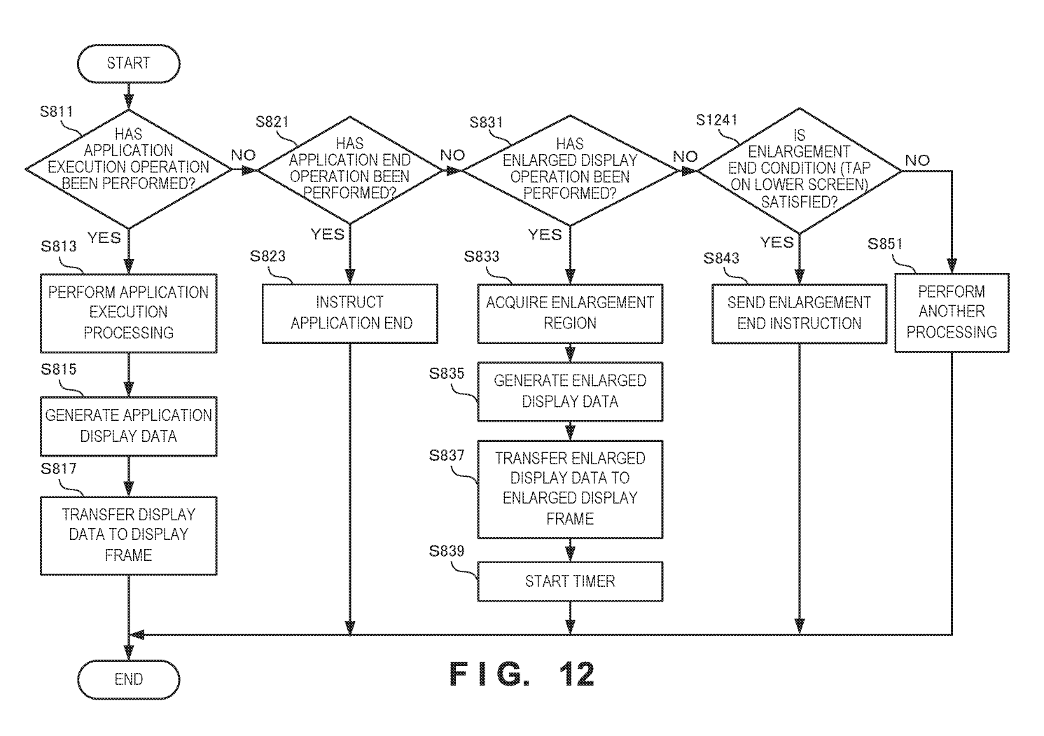

FIG. 12 is a flowchart illustrating the processing procedure of the information processing apparatus 1000 according to this embodiment. This flowchart is executed by a CPU 710 of FIG. 7 using a RAM 740, thereby implementing the functional components of FIG. 3. Note that in FIG. 12, the same step numbers as those in FIG. 8 denote the same steps, and a description thereof will be omitted.

If none of an application execution operation, an application end operation, and a content enlargement operation has been performed, the information processing apparatus 1000 determines in step S1241 whether an enlarged display end condition based on a tap operation is satisfied. If the enlarged display end condition is satisfied, in this example, when a tap operation is performed outside the region of the enlarged and displayed content, the information processing apparatus 1000 sends an enlargement end instruction in step S843.

According to this embodiment, after enlarging and displaying, in accordance with an enlargement operation on the screen, a content in a divided screen in a size easy to see without limitation to the divided screen, it is possible to continue the enlarged display until an enlargement end operation is performed by a tap.

### Fourth Embodiment

An information processing apparatus according to the fourth embodiment of the present invention will be described next. The information processing apparatus according to this embodiment is different from those according to the second and third embodiments in that enlarged display is continued and an enlargement end operation is performed when the size of the enlarged content becomes small. The remaining components and operations are the same as those in the second embodiment. Hence, the same reference numerals denote the same components and operations, and a detailed description thereof will be omitted.

### Enlargement End Processing Operation

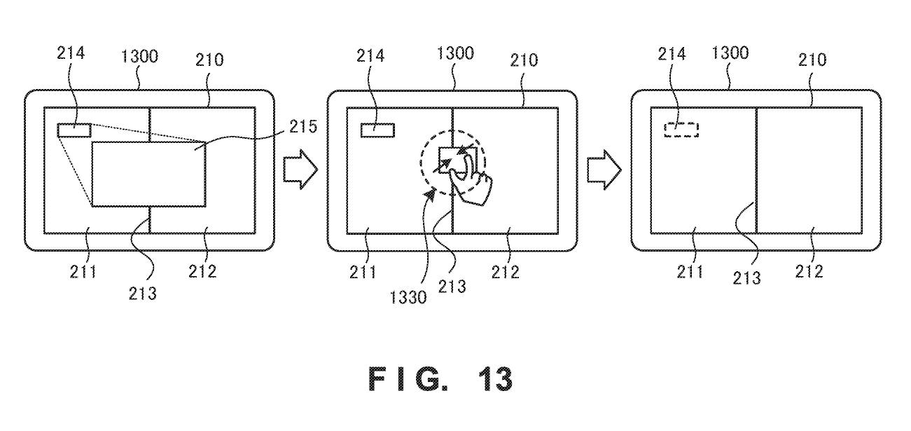

FIG. 13 is a view showing the operation of the enlargement end processing of an information processing apparatus 1300 according to this embodiment. FIG. 13 shows, from left, the enlargement operation and enlarged display of a content 214, an enlargement end operation, and a state after the end of enlargement.

Screens 211 and 212 are divisionally displayed on a display screen 210 of the information processing apparatus 1300 to have a boundary 213. If an enlargement instruction is issued for the content 214, an enlarged content 215 is superimposed and displayed on the boundary 213 between the screens 211 and 212.

If reduction processing is performed for the enlarged and displayed content 215 by, for example, a pinch-in operation 1330 during enlarged display, and the display size of the content becomes equal to or smaller than a threshold, the enlarged display processing ends to return to the original divided display (see the right view). Note that FIG. 13 shows an example in which content display is reduced by the pinch-in operation 1330. However, another reduction operation may be performed.

### Enlargement End Determination Table

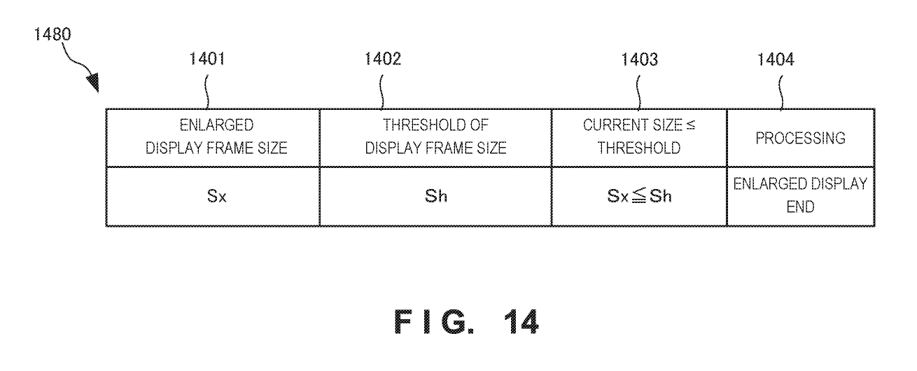

FIG. 14 is a table showing the structure of an enlargement end determination table 1480 according to this embodiment. The enlargement end determination table 1480 is used to determine an operation of ending the enlarged display of the content. Note that in this example, if the display size of the content becomes equal to or smaller than a threshold by reduction processing such as a pinch-in operation, the end of the enlarged display is determined. In this embodiment, the enlargement end determination table 1480 is used instead of the enlargement end determination table 380 shown in FIG. 3.

The enlargement end determination table 1480 stores a current enlarged display frame size (Sx) 1401, a threshold (Sh) 1402 of a size, a comparison result 1403 of the size Sx and the threshold Sh, and processing 1404. In FIG. 14, since “enlarged display frame size Sx≦threshold Sh” holds, enlarged display end processing is determined.

### Processing Procedure of Information Processing Apparatus

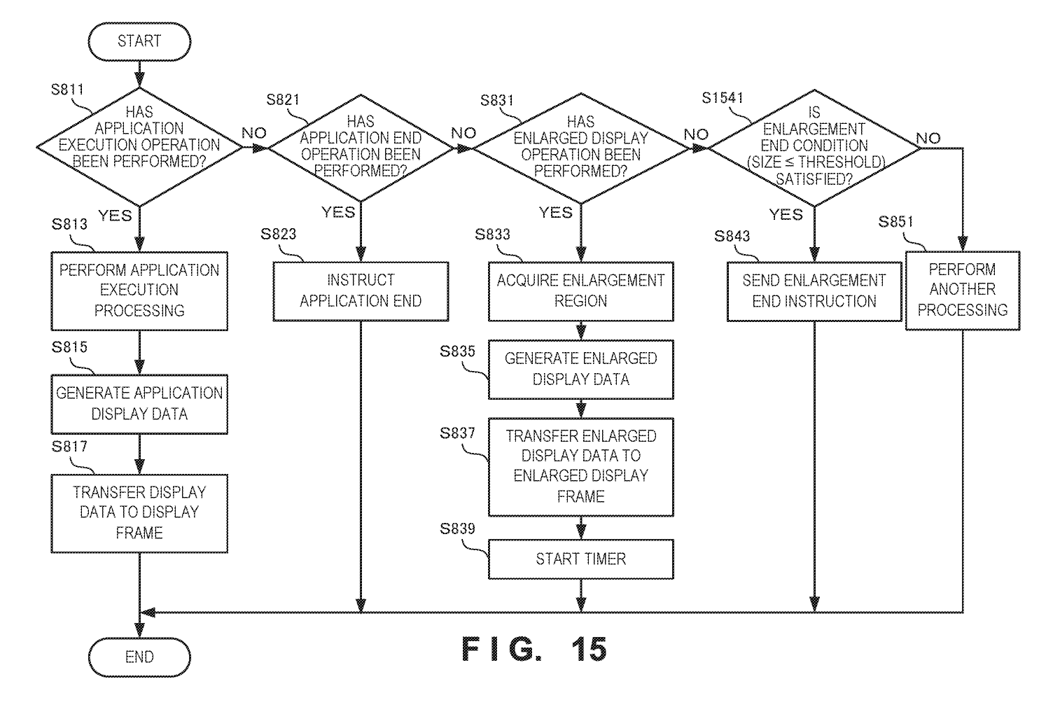

FIG. 15 is a flowchart illustrating the processing procedure of the information processing apparatus 1300 according to this embodiment. This flowchart is executed by a CPU 710 of FIG. 7 using a RAM 740, thereby implementing the functional components of FIG. 3. Note that in FIG. 15, the same step numbers as those in FIG. 8 denote the same steps, and a description thereof will be omitted.

If none of an application execution operation, an application end operation, and a content enlargement operation has been performed, the information processing apparatus 1300 determines in step S1541 whether an enlarged display end condition based on an enlarged display frame size is satisfied. If the enlarged display end condition is satisfied, in this example, when the enlarged display frame size is equal to or smaller than the threshold, the information processing apparatus 1300 sends an enlargement end instruction in step S843.

According to this embodiment, after enlarging and displaying, in accordance with an enlargement operation on the screen, a content in a divided screen in a size easy to see without limitation to the divided screen, it is possible to continue the enlarged display until an enlargement end operation is performed by reducing the content.

### Fifth Embodiment

An information processing apparatus according to the fifth embodiment of the present invention will be described next. The information processing apparatus according to this embodiment is different from those according to the second to fourth embodiments in that enlarged display is performed during an enlargement operation, and ends upon end of the enlargement operation. The remaining components and operations are the same as those in the second embodiment. Hence, the same reference numerals denote the same components and operations, and a detailed description thereof will be omitted.

### Enlargement End Processing Operation

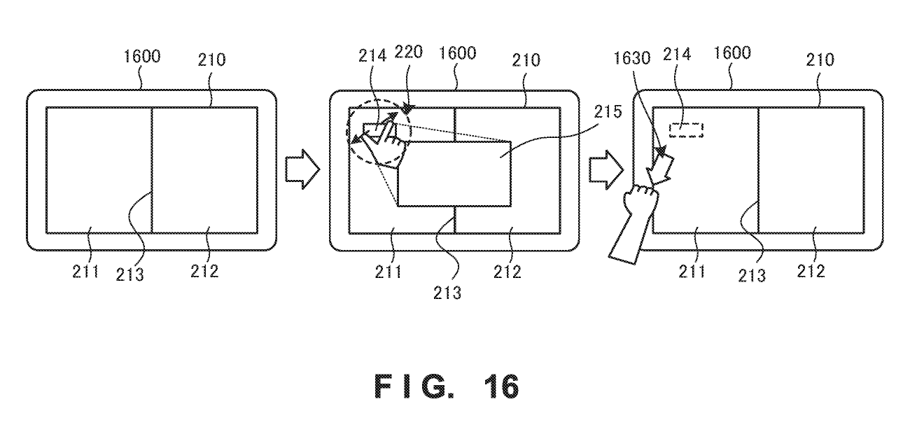

FIG. 16 is a view showing the operation of the enlargement end processing of an information processing apparatus 1600 according to this embodiment. FIG. 16 shows, from left, divided screens, the enlargement operation and enlarged display of a content 214, and the end of enlargement.

Screens 211 and 212 are divisionally displayed on a display screen 210 of the information processing apparatus 1600 to have a boundary 213. In this example, if an enlargement instruction for the content 214 displayed on one screen 211 is issued by a pinch-out operation 220, an enlarged content 215 is superimposed and displayed on the boundary 213 between the screens 211 and 212.

If a finger used to perform the enlargement operation is released from the display screen (1630), the enlarged display processing ends to return to the original divided display (see the right view).

### Enlargement Processing Determination Table

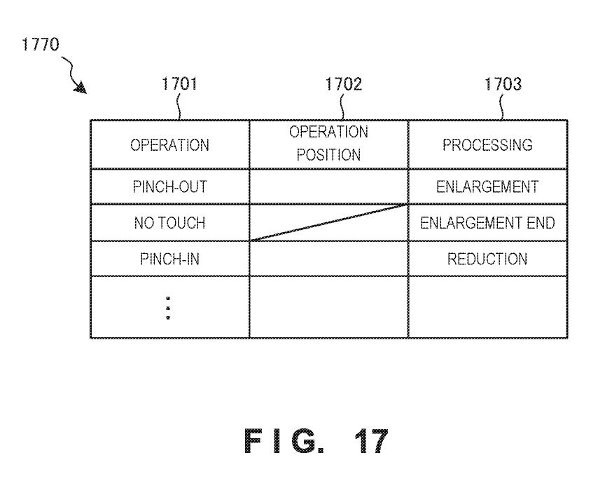

FIG. 17 is a table showing the structure of an enlargement processing determination table 1770 according to this embodiment. The enlargement processing determination table 1770 is used to determine an operation of instructing enlarged display of a content and the end of the enlarged display. Note that a case in which a pinch-out operation as a touch operation by the user on the display screen corresponds to an enlargement operation will be described with reference to FIG. 17. For example, however, the enlargement operation is not limited to this, and may be a touch on an enlargement button on the screen. In this embodiment, the enlargement processing determination table 1770 is used instead of the enlargement processing determination table 370 and enlargement end determination table 380 of FIG. 3.

The enlargement processing determination table 1770 stores processing 1703 in association with an operation 1701 and an operation position 1702. In this example, if no touch is detected any more, the enlarged display ends.

### Processing Procedure of Information Processing Apparatus

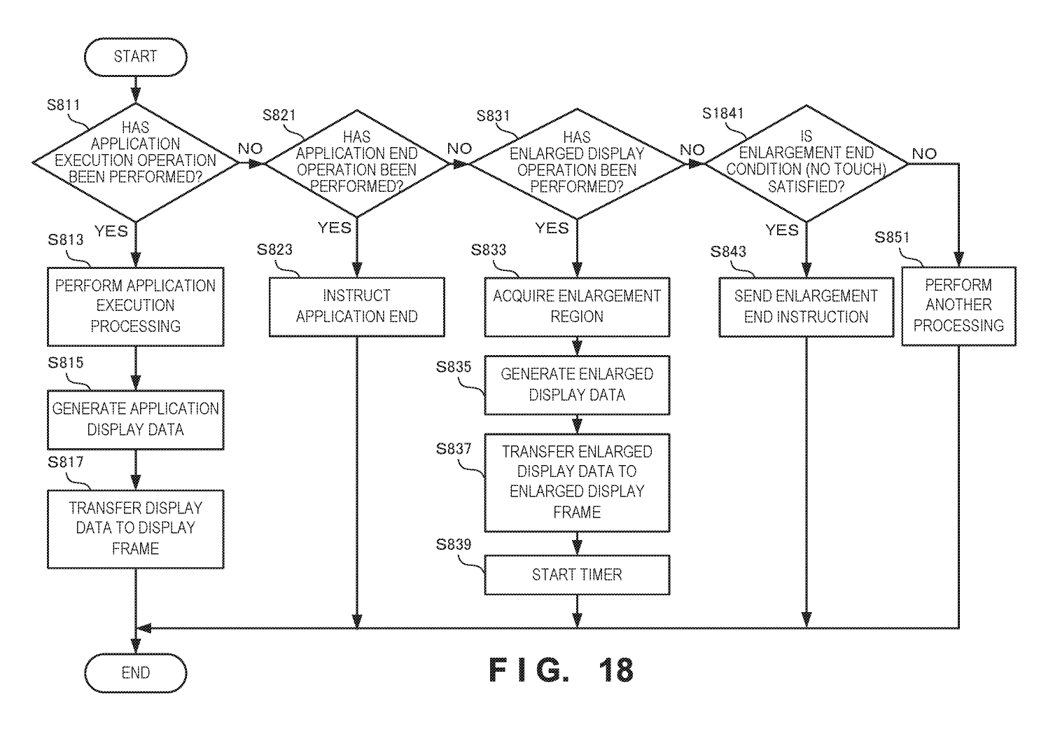

FIG. 18 is a flowchart illustrating the processing procedure of the information processing apparatus 1600 according to this embodiment. This flowchart is executed by a CPU 710 of FIG. 7 using a RAM 740, thereby implementing the functional components of FIG. 3. Note that in FIG. 18, the same step numbers as those in FIG. 8 denote the same steps, and a description thereof will be omitted.

If none of an application execution operation, an application end operation, and a content enlargement operation has been performed, the information processing apparatus 1600 determines in step S1841 whether an enlarged display end condition based on touch detection is satisfied. If the enlarged display end condition is satisfied, in this example, when no touch is detected, the information processing apparatus 1600 sends an enlargement end instruction in step S843.

According to this embodiment, after enlarging and displaying, in accordance with an enlargement operation on the screen, a content in a divided screen in a size easy to see without limitation to the divided screen, it is possible to end the enlarged display upon end of the enlargement operation.

### Sixth Embodiment

An information processing apparatus according to the sixth embodiment of the present invention will be described next. The information processing apparatus according to this embodiment is different from those according to the second to fifth embodiments in that an enlargement target content is a content emphasizing an image in the display region of facebook or the like. The remaining components and operations are the same as those in the second to fifth embodiments. Hence, the same reference numerals denote the same components and operations, and a detailed description thereof will be omitted.

### Enlargement Processing Operation

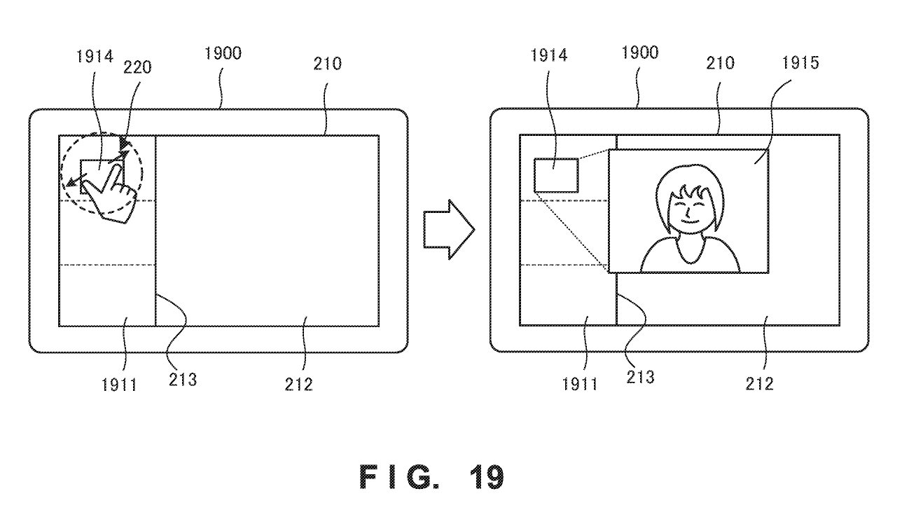

FIG. 19 is a view showing the operation of the enlargement processing of an information processing apparatus 1900 according to this embodiment. FIG. 19 shows, from left, divided screens (one screen is a facebook screen with a small size), and the enlargement operation and enlarged display of a content 1914 in the facebook screen.

A facebook screen 1911 and a screen 212 are divisionally displayed on a display screen 210 of the information processing apparatus 1900 to have a boundary 213. In this example, if an enlargement instruction for the content 1914 displayed on the facebook screen 1911 is issued by a pinch-out operation 220, an enlarged content 1915 is superimposed and displayed on the boundary 213 between the facebook screen 1911 and the screen 212 (the right view).

According to this embodiment, even if another screen is currently displayed, the user can see a small received image or moving image by SNS or the like by temporarily enlarging the image and superimposing it on the other screen.

### Seventh Embodiment

An information processing apparatus according to the seventh embodiment of the present invention will be described next. The information processing apparatus according to this embodiment is different from those according to the second to sixth embodiments in that when three divided screens are displayed, a content in one screen is enlarged and displayed. The remaining components and operations are the same as those in the second to sixth embodiments. Hence, the same reference numerals denote the same components and operations, and a detailed description thereof will be omitted.

### Enlargement Processing Operation

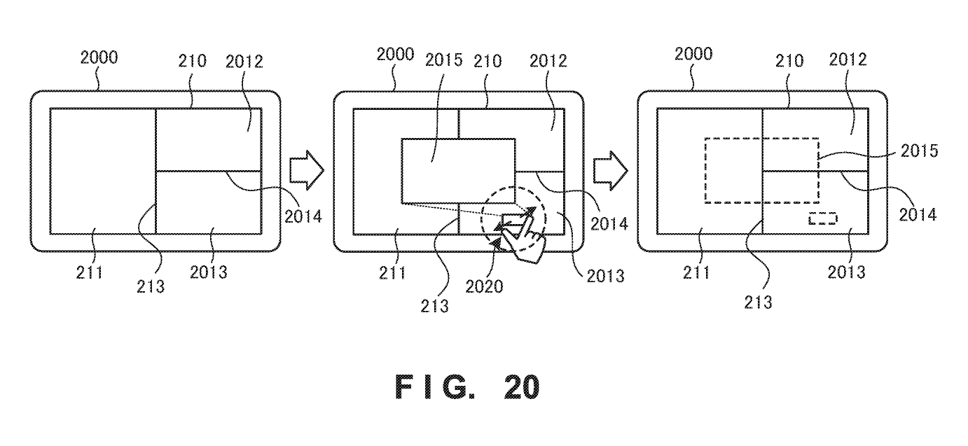

FIG. 20 is a view showing the operation of the enlargement processing of an information processing apparatus 2000 according to this embodiment. FIG. 20 shows, from left, three divided screens, the enlargement operation and enlarged display of a content, and the end of enlargement.

Screens 211, 2012, and 2013 are divisionally displayed on a display screen 210 of the information processing apparatus 2000 to have boundaries 213 and 2014 (see the left view). In this example, if an enlargement instruction for the content displayed on the screen 2013 is issued by a pinch-out operation 2020, an enlarged content 2015 is superimposed and displayed on the boundaries 213 and 2014 (see the central view).

If a predetermined time elapses while no operation is performed for the enlarged content after the enlarged display processing is performed, the enlarged display processing ends to return to the original divided display (see the right view).

Note that the enlarged content is superimposed and displayed on the boundaries 213 and 2014 in FIG. 20 but may be superimposed and displayed on one of the boundaries 213 and 2014. Alternatively, the enlarged content may be superimposed and displayed on a boundary close to the content instructed to be enlarged.

According to this embodiment, even if three divided screens are displayed, it is possible to enlarge and display a content in a divided screen in a size easy to see without limitation to the divided screen.

### Other Embodiments

The above embodiments have described the divided screens in the horizontal direction or the two or three divided screens. However, the same processing is performed for divided screens in the vertical direction or four or more divided screens and it is possible to obtain the same effect.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. The scope of the following claims is to be accorded the broadest interpretation so as to encompass all such modifications and equivalent structures and functions.

The present invention is applicable to a system including a plurality of devices or a single apparatus. The present invention is also applicable even when a control program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-188304 filed on Sep. 16, 2014, which is hereby incorporated by reference herein in its entirety.

1. An information processing apparatus comprising:
a divided display control unit that displays at least two divided screens; and
an enlarged display control unit that displays, when enlarging a content in one of the at least two divided screens, the enlarged content with superimposing the enlarged content on a boundary between the at least two divided screens.

2. The information processing apparatus according to claim 1, wherein said enlarged display control unit includes an enlargement operation determiner that determines an enlargement operation of the content in the at least two screens, and enlarges the content in accordance with the enlargement operation and displays the enlarged content with superimposing the enlarged content on the boundary between the at least two divided screens.

3. The information processing apparatus according to claim 1, wherein said enlarged display control unit generates a display frame that is different from display frames of the at least divided screens and includes the enlarged content, and displays the display frame with superimposing the display frame on the boundary between the at least two divided screens.

4. The information processing apparatus according to claim 1, wherein the content is an image.

5. The information processing apparatus according to claim 1, further comprising:
an enlarged display end unit that ends the display of the enlarged content by said enlarged display control unit.

6. The information processing apparatus according to claim 5, wherein said enlarged display end unit, when determining that one of the at least two divided screens has been touched, ends the display of the enlarged content.

7. The information processing apparatus according to claim 5, wherein said enlarged display end unit, determining that a display size of the enlarged content is not larger than a threshold, ends the display of the enlarged content.

8. The information processing apparatus according to claim 5, wherein said enlarged display end unit, when determining that no operation has been performed for the enlarged content for a predetermined elapsed time, ends the display of the enlarged content.

9. The information processing apparatus according to claim 2, wherein, while accepting the enlargement operation, said enlarged display control unit displays the enlarged content with superimposing the enlarged content on the boundary between the at least divided screens.

10. The information processing apparatus according to claim 1, wherein the at least two divided screens are windows respectively opened by activating different applications.

11. A method of controlling an information processing apparatus, comprising:
displaying at least two divided screens; and
displaying, when enlarging a content in one of the at least two divided screens, the enlarged content with superimposing the enlarged content on a boundary between the at least two divided screens.

12. A non-transitory computer-readable storage medium storing a program of controlling an information processing apparatus for causing a computer to execute a method, comprising:
displaying at least two divided screens; and
displaying, when enlarging a content in one of the at least two divided screens, the enlarged content with superimposing the enlarged content on a boundary between the at least two divided screens.

13. A method of enlarging a content in at least two divided screens, comprising:
determining an enlargement operation of a content in the at least two divided screens; and
enlarging the content in accordance with the enlargement operation and displaying the enlarged content with superimposing the enlarged content on a boundary between the at least two divided screens.

14. The information processing apparatus according to claim 1, wherein said enlarged display control unit generates a display frame that is different from display frames of the at least divided screens and includes the enlarged content, and displays the display frame with superimposing the display frame on the boundary between the at least two divided screens.

15. The information processing apparatus according to claim 2, further comprising:
an enlarged display end unit that ends the display of the enlarged content by said enlarged display control unit.
